(19) United States
(12) Patent Application Publication
(10) Pub. No.: US 2020/0283174 A1
(43) Pub. Date: Sep. 10, 2020

(54) SPACECRAFT THERMAL AND FLUID MANAGEMENT SYSTEMS

(71) Applicant: MOMENTUS INC., Santa Clara, CA (US)

(72) Inventors: Mikhail Kokorich, Santa Clara, CA (US); Joel Sercel, Santa Clara, CA (US); Aaron Mitchell, Santa Clara, CA (US); Gedi Minster, Santa Clara, CA (US); Yuqi Wang, Santa Clara, CA (US); Lee Wilson, Santa Clara, CA (US); James Small, Santa Clara, CA (US)

(21) Appl. No.: 16/773,901

(22) Filed: Jan. 27, 2020

Related U.S. Application Data
(60) Provisional application No. 62/819,355, filed on Mar. 15, 2019.
(60) Provisional application No. 62/817,206, filed on Mar. 12, 2019.
(60) Provisional application No. 62/814,484, filed on Mar. 6, 2019.
(60) Provisional application No. 62/813,481, filed on Mar. 4, 2019.

(51) Int. Cl. B64G 1/40; F17C 7/04; F02K 9/56

(52) U.S. Cl. CPC B64G 1/402; F17C 7/04; F02K 9/563; F17C 2225/013; F17C 2223/0153; F17C 2225/0123; F17C 2270/0197

(57) ABSTRACT

To manage propellant in a spacecraft, the method of this disclosure includes storing propellant in a tank as a mixture of liquid and gas; transferring the propellant out of the tank; converting the mixture of liquid and gas propellant into a single phase, where the single phase is either liquid or gaseous; and supplying the single phase of the propellant to a thruster.

### CROSS-REFERENCE TO RELATED APPLICATIONS

The present application is a non-provisional application claiming priority to U.S. Provisional Patent Application No. 62/813,481, filed on Mar. 4, 2019 and titled “Method and System for Reversing Phase Separation of Fluids in Microgravity”; U.S. Provisional Patent Application No. 62/814,484, filed on Mar. 6, 2019 and titled “Microwave Magnetron with Heat Pipe Cooling for Space Applications”; U.S. Provisional Patent Application No. 62/819,355, filed on Mar. 15, 2019 and titled “Rapid Valve Actuated Pumping System and Method,” and U.S. Provisional Patent Application No. 62/817,206, filed on Mar. 12, 2019 and titled “Capillary Action Pumping of Fluids in Microgravity,” the disclosure of each of which is incorporated herein by reference in its entirety for all purposes.

### FIELD OF THE DISCLOSURE

The disclosure generally relates to operating a spacecraft and more specifically to managing the fluid propellant and heat in the spacecraft systems.

### BACKGROUND

With increased commercial and government activity in the near space, a variety of spacecraft and missions are under development. For example, some spacecraft may be dedicated to delivering payloads (e.g., satellites) from one orbit to another. In the course of missions, managing the propellant and heat efficiently remains a challenge.

### SUMMARY

Generally speaking, the techniques of this disclosure improve management of thermal energy in a spacecraft as well as transfer of energy between subsystems of the spacecraft. As discussed in more detail below, these techniques allow the spacecraft to more efficiently utilize a fluid propellant stored in multiple phases (e.g., liquid and gaseous), remove excess heat from subsystems, store excess heat in a propellant tank, direct stored heat from a propellant tank to another component, etc.

One example embodiment of the techniques of this disclosure is a method for managing propellant in a spacecraft. The method includes storing propellant in a tank as a mixture of liquid and gas, transferring the propellant out of the tank, converting the mixture of liquid and gas propellant into a single phase, where the single phase is either liquid or gaseous, and supplying the single phase of the propellant to a thruster.

Another example embodiment of these techniques is a system for managing propellant in a spacecraft. The system includes a tank for storing propellant as a mixture of liquid and gas; a two-phase intake device configured to operate at a variable volume flow rate; a sensor configured to generate a signal indicative of an amount of liquid in the mixture of liquid and gas; and a controller configured to vary the variable flow rate of the two-phase intake device based at least in part on the signal generated by the sensor.

Still another example embodiment of these techniques is a method for transferring propellant out of a tank that stores the propellant in microgravity as a mixture of gas and liquid. The includes pumping with a two-phase pump a certain volume of propellant via an outlet line; determining, using a sensor, a ratio of liquid and gas in the certain volume; and setting a speed of pumping with the two-phase pump based at least in part on the determined ratio.

Another example embodiment of these techniques is a system for managing heat in a spacecraft. The system includes a tank configured to store a propellant; a microwave electro-thermal (MET) thruster configured to consume the propellant to generate thrust, the thruster including a microwave source that, in operation, generates excess heat; and a heat exchanger configured to transfer the excess heat to the propellant stored in thank.

Yet another embodiment of these techniques is a method for managing heat in a spacecraft. The method includes operating a microwave electro-thermal (MET) thruster including a microwave source. Operating the MET thruster includes: consuming propellant, and generating excess heat. The method further includes heating an amount of the propellant using the excess heat; storing the excess heat by storing the heated amount of the propellant in a tank; and directing the excess heat to a subsystem of the spacecraft.

Another embodiment of these techniques is a system for managing heat in a spacecraft. The system includes a tank configured to store a propellant; a microwave electro-thermal (MET) thruster configured to consume the propellant to generate thrust, the thruster including a microwave source that, in operation, generates excess heat; a heat exchanger configured to transfer the excess heat to a portion of the propellant in a conduit, thereby heating the portion of the propellant; and a pump configured to direct the heated portion of the propellant to a heat sink.

Another embodiment of these techniques is a system for managing heat in a spacecraft. The system includes a deployable radiator; and a conduit having a flexible section and configured for carrying a propellant, the conduit in a thermally conductive connection with the deployable radiator.

Another embodiment of these techniques is a system for managing heat in a spacecraft. The system includes a radiator, disposed at a back side of a solar panel; a conduit having a flexible section and configured for carrying a propellant, the conduit in a thermally conductive connection with the radiator; and a pump configured to pump propellant through the conduit.

Another embodiment of these techniques is a system for storing propellant in microgravity. The system includes a tank for storing propellant as a mixture of liquid and gas; and an agitator, configured to increase circulation of the mixture of liquid and gas in microgravity; and a controller configured to activate the agitator

### BRIEF DESCRIPTION OF THE DRAWINGS

FIG. 1 is a block diagram of an example spacecraft in which the techniques of this disclosure can be implemented;

FIGS. 2A-C illustrate three configurations of a propellant management system for converting a two-phase mixture of propellant stored in a tank into a single phase for supplying the propellant to a thruster;

FIG. 3 illustrates an of a propellant management system for converting a two-phase mixture of propellant into a single phase using a piston pump;

FIG. 4A illustrates a system for controlling a volume flow rate of a two-phase mixture from a tank based on a sensor for detecting a composition of the two-phase mixture;

FIG. 4B illustrates a system for controlling a volume flow rate of a two-phase mixture from a tank based on a sensor for detecting a composition of a sample of the two-phase mixture removed from the tank by a sampling pump;

FIG. 5 illustrates a general architecture of using a propellant system for managing heat in a spacecraft;

FIG. 6 illustrates an example implementation of using a propellant system for managing heat in a spacecraft by pumping propellant through one or more heat exchangers.

FIG. 7A illustrates a deployable radiator thermally connected to a propellant conduit with a flexible section.

FIG. 7B illustrates a radiator attached to a back side of a solar array and thermally connected to a propellant conduit.

FIG. 8A illustrates a tank for storing propellant, the tank including an ultrasonic transducer acting as an agitator for increasing circulation of a mixture of liquid and gas in microgravity.

FIG. 8B illustrates a tank for storing propellant, the tank including a fan acting as an agitator for increasing circulation of a mixture of liquid and gas in microgravity.

### DETAILED DESCRIPTION

A spacecraft of this disclosure may be configured for transferring a payload from a lower energy orbit to a higher energy orbit according to a set of mission parameters. The mission parameters may include, for example, a time to complete the transfer and an amount of propellant and/or fuel available for the mission. Generally, the spacecraft may collect solar energy and use the energy to power one or more thrusters. Different thruster types and/or operating modes may trade off the total amount of thrust with the efficiency of thrust with respect to fuel or propellant consumption, defined as a specific impulse.

The spacecraft in some implementations includes thrusters of different types to improve the efficiency of using solar energy when increasing orbital energy. In some implementations, the spacecraft uses the same subsystems for operating the different-type thrusters, thereby reducing the mass and/or complexity of the spacecraft, and thus decreasing mission time while maintaining and/or improving reliability. Additionally or alternatively, the spacecraft can choose or alternate between thrusters of different types as primary thrusters. The spacecraft can optimize these choices for various mission goals (e.g., different payloads, different destination orbits) and/or mission constraints (e.g., propellant availability). Example optimization of these choices can include variations in collecting and storing solar energy as well as in controlling when the different thrusters use the energy and/or propellant, as discussed below.

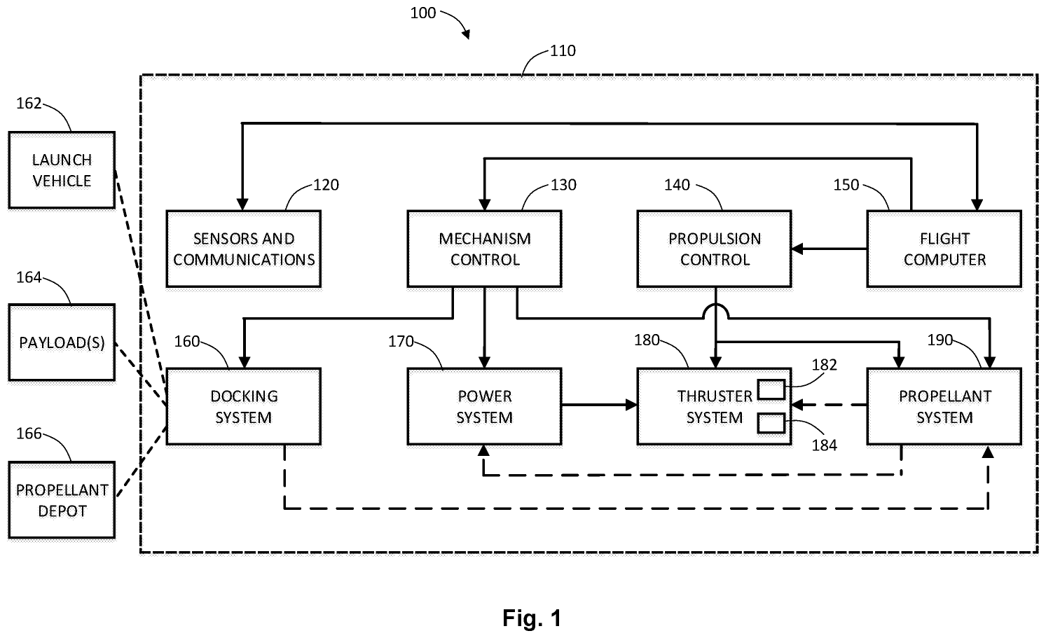

FIG. 1 is a block diagram of a spacecraft 100 configured for transferring a payload between orbits. The spacecraft 100 includes several subsystems, units, or components disposed in or at a housing 110. The subsystems of the spacecraft 100 may include sensors and communications components 120, mechanism control 130, propulsion control 140, a flight computer 150, a docking system 160 (for attaching to a launch vehicle 162, one or more payloads 164, a propellant depot 166, etc.), a power system 170, a thruster system 180 that includes a first thruster 182 and a second thruster 184, and a propellant system 190. Furthermore, any combination of subsystems, units, or components of the spacecraft 100 involved in determining, generating, and/or supporting spacecraft propulsion (e.g., the mechanism control 130, the propulsion control 140, the flight computer 150, the power system 170, the thruster system 180, and the propellant system 190) may be collectively referred to as a propulsion system of the spacecraft 100.

The sensors and communications components 120 may several sensors and/or sensor systems for navigation (e.g., imaging sensors, magnetometers, inertial motion units (IMUs), Global Positioning System (GPS) receivers, etc.), temperature, pressure, strain, radiation, and other environmental sensors, as well as radio and/or optical communication devices to communicate, for example, with a ground station, and/or other spacecraft. The sensors and communications components 120 may be communicatively connected with the flight computer 150, for example, to provide the flight computer 150 with signals indicative of information about spacecraft position and/or commands received from a ground station.

The flight computer 150 may include one or more processors, a memory unit, computer readable media, to process signals received from the sensors and communications components 120 and determine appropriate actions according to instructions loaded into the memory unit (e.g., from the computer readable media). Generally, the flight computer 150 may be implemented any suitable combination of processing hardware, that may include, for example, applications specific integrated circuits (ASICs) or field programmable gate arrays (FPGAs), and/or software components. The flight computer 150 may generate control messages based on the determined actions and communicate the control messages to the mechanism control 130 and/or the propulsion control 140. For example, upon receiving signals indicative of a position of the spacecraft 100, the flight computer 150 may generate a control message to activate one of the thrusters 182, 184 in the thruster system 180 and send the message to the propulsion control 140. The flight computer 150 may also generate messages to activate and direct sensors and communications components 120.

The docking system 160 may include a number of structures and mechanisms to attach the spacecraft 100 to a launch vehicle 162, one or more payloads 164, and/or a propellant refueling depot 166. The docking system 160 may be fluidicly connected to the propellant system 190 to enable refilling the propellant from the propellant depot 166. Additionally or alternatively, in some implementations at least a portion of the propellant may be disposed on the launch vehicle 162 and outside of the spacecraft 100 during launch. The fluidic connection between the docking system 160 and the propellant system 190 may enable transferring the propellant from the launch vehicle 162 to the spacecraft 100 upon delivering and prior to deploying the spacecraft 100 in orbit.

The power system 170 may include components (discussed in the context of FIGS. 4-7) for collecting solar energy, generating electricity and/or heat, storing electricity and/or heat, and delivering electricity and/or heat to the thruster system 180. To collect solar energy into the power system 170, solar panels with photovoltaic cells, solar collectors or concentrators with mirrors and/or lenses, or a suitable combination of devices may collect solar energy. In the case of using photovoltaic devices, the power system 170 may convert the solar energy into electricity and store it in energy storage devices (e.g, lithium ion batteries, fuel cells, etc.) for later delivery to the thruster system 180 and other spacecraft components. In some implementations, the power system 180 may deliver at least a portion of the generated electricity directly to the thruster system 180 and/or to other spacecraft components. When using a solar concentrator, the power system 170 may direct the concentrated (having increased irradiance) solar radiation to photovoltaic solar cells to convert to electricity. In other implementations, the power system 170 may direct the concentrated solar energy to a solar thermal receiver or simply, a thermal receiver, that may absorb the solar radiation to generate heat. The power system 170 may use the generated heat to power a thruster directly, as discussed in more detail below, to generate electricity using, for example, a turbine or another suitable technique (e.g., a Stirling engine). The power system 170 then may use the electricity directly for generating thrust or store electric energy as briefly described above, or in more detail below.

The thruster system 180 may include a number of thrusters and other components configured to generate propulsion or thrust for the spacecraft 100. Thrusters may generally include main thrusters that are configured to substantially change speed of the spacecraft 100, or as attitude control thrusters that are configured to change direction or orientation of the spacecraft 100 without substantial changes in speed. In some implementations, the first thruster 182 and the second thruster 184 may both be configured as main thrusters, with additional thrusters configured for attitude control. The first thruster 182 may operate according to a first propulsion technique, while the second thruster 184 may operate according to a second propulsion technique.

For example, the first thruster 182 may be a microwave-electro-thermal (MET) thruster. In a MET thruster cavity, an injected amount of propellant may absorb energy from a microwave source (that may include one or more oscillators) included in the thruster system 180 and, upon partial ionization, further heat up, expand, and exit the MET thruster cavity through a nozzle, generating thrust.

The second thruster 184 may be a solar thermal thruster. In one implementation, propellant in a thruster cavity acts as the solar thermal receiver and, upon absorbing concentrated solar energy, heats up, expands, and exits the nozzle generating thrust. In other implementations, the propellant may absorb heat before entering the cavity either as a part of the thermal target or in a heat exchange with the thermal target or another suitable thermal mass thermally connected to the thermal target. In some implementations, while the propellant may absorb heat before entering the thruster cavity, the thruster system 180 may add more heat to the propellant within the cavity using an electrical heater or directing a portion of solar radiation energy to the cavity.

The propellant system 190 may store the propellant for use in the thruster system 180. The propellant may include water, hydrogen peroxide, hydrazine, ammonia or another suitable substance. The propellant may be stored on the spacecraft in solid, liquid, and/or gas phase. To that end, the propellant system 190 may include one or more tanks. To move the propellant within the spacecraft 100, and to deliver the propellant to one of the thrusters, the propellant system may include one or more pumps, valves, and pipes. As described below, the propellant may also store heat and/or facilitate generating electricity from heat, and the propellant system 190 may be configured, accordingly, to supply propellant to the power system 170.

The mechanism control 130 may activate and control mechanisms in the docking system 160 (e.g., for attaching and detaching payload or connecting with an external propellant source), the power system 170 (e.g., for deploying and aligning solar panels or solar concentrators), and/or the propellant system (e.g., for changing configuration of one or more deployable propellant tanks). Furthermore, the mechanism control 130 may coordinate interaction between subsystems, for example, by deploying a tank in the propellant system 190 to receive propellant from an external source connected to the docking system 160.

The propulsion control 140 may coordinate the interaction between the thruster system 140 and the propellant system 190, for example, by activating and controlling electrical components (e.g., a microwave source) of the thruster system 140 and the flow of propellant supplied to thrusters by the propellant system 190. Additionally or alternatively, the propulsion control 140 may direct the propellant through elements of the power system 170. For example, the propellant system 190 may direct the propellant to absorb the heat (e.g., at a heat exchanger) accumulated within the power system 170. Vaporized propellant may then drive a power plant (e.g., a turbine, a Stirling engine, etc.) of the power system 170 to generate electricity. Additionally or alternatively, the propellant system 190 may direct some of the propellant to charge a fuel cell within the power system 190.

The subsystems of the spacecraft may be merged or subdivided in different implementations. For example, a single control unit may control mechanisms and propulsion. Alternatively, dedicated controllers may be used for different mechanisms (e.g., a pivot system for a solar concentrator), thrusters (e.g., a MET thruster), valves, etc. In the following discussion, a controller may refer to any portion or combination of the mechanism control 130 and/or propulsion control 140.

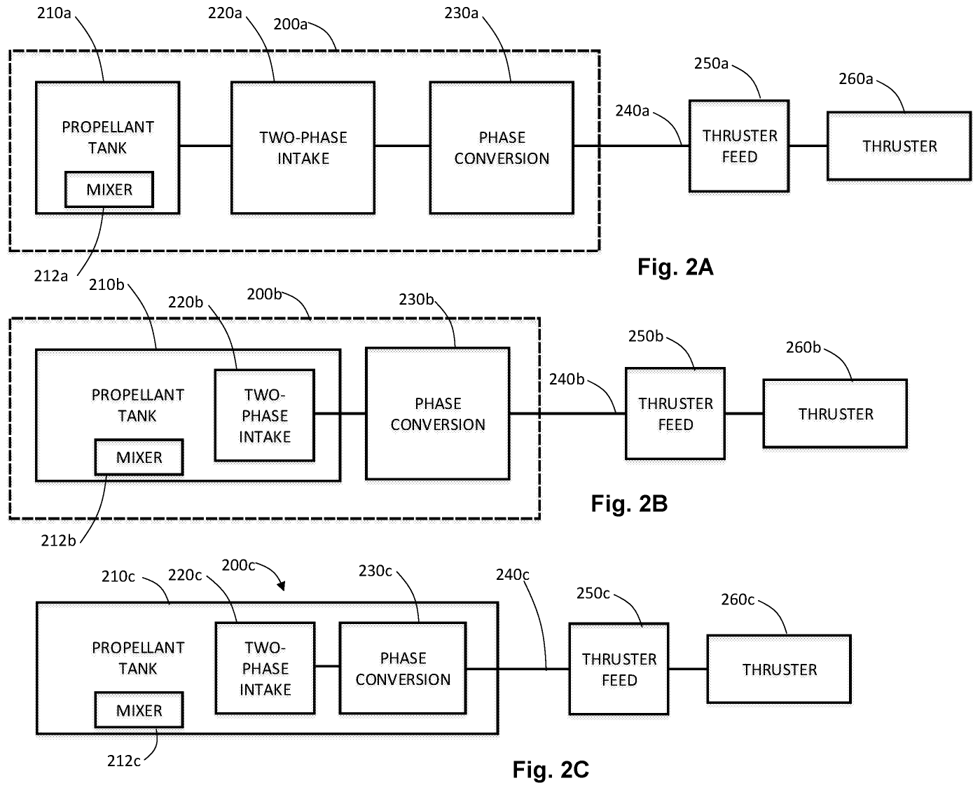

FIGS. 2A-C illustrate three configurations of propellant management systems 200a-c for converting a two-phase mixture of propellant stored in a tank into a single phase for supplying the propellant to a thruster. The propellant management systems 200a-c include propellant tanks 210a-c, with optional mixers 212a-c (also referred to as agitators), sequentially fluidicly coupled to corresponding two-phase intake components 220a-c and phase-conversion components 230a-c. Outlet lines 240a-c of the propellant management systems 200a-c supply propellant to corresponding thruster feeds 250a-c and thrusters 260a-c.

In FIG. 2A, the configuration 200a includes the propellant tank 210a, optionally, with the mixer 212a disposed within the tank 210a. The two-phase intake component 220a receives a mixture of liquid and gas propellant and transfers the mixture out the tank 210a. The two-phase intake component 220a transfers the two-phase mixture to the phase conversion component 230a. In some implementations, the two-phase intake component 220a may include a two-phase pump. In other implementations, a single-phase pump may be connected downstream of the phase conversion component 230a to establish a pressure gradient across the two-phase intake component 220a to draw the propellant out of the tank 210a.

The phase conversion component 230a is configured to convert the two-phase mixture of the propellant into a single phase. The single-phase propellant exiting the phase-conversion component 230a through the outlet line 240a may be either all liquid or all gas. The outlet line 240a may supply the single phase of the propellant to the thruster feed component 250a. The thruster feed component 250a may, for example, accumulate liquid propellant and supply the propellant to a thruster 260a when the thruster is in operation. The thruster feed component 250a may vaporize the liquid propellant prior to supplying in to the thruster 260a. In some implementations, the propellant management system 200a may supply the propellant directly to the thruster 260a in gas phase.

The phase conversion component 230a may convert the mixture of liquid and gas propellant directly into liquid by increasing pressure and/or decreasing temperature to condense the gas portion of the propellant. In some implementations, the two phase intake component 220a may include a section of porous wicking material (e.g., a sponge) that adsorbs and wicks the liquid and gas propellant. The phase conversion component 230a may include a mechanism for compressing the porous wicking material to extract the liquid phase of the propellant. In some implementations, the phase conversion component includes an expansion nozzle, a rapid valve, a heating section and/or another suitable mechanisms for evaporating the propellant to fully convert the propellant to gas. In some implementations, the phase conversion component 230a directs the gas propellant to the outlet line 240a. In other implementations, the phase conversion component 230a includes a section for fully condensing the evaporated propellant and directing the all-liquid propellant to the supply line 240a.

FIG. 2B illustrates another configuration, where the two-phase intake component 220b is disposed within the tank 210b. For example, the two-phase intake component 220b may be an impeller. The impeller may be configured to use centrifugal phase separation to preferentially supply the liquid phase of the propellant to the phase conversion component 230b. The two-phase intake component may also include a section of porous wicking material, as described above.

In FIG. 2C, the configuration with both the two-phase intake component 220c and the phase conversion component 230c disposed within the tank 210c. For example, the two-phase intake component 220c may include a section of porous wicking material disposed within the tank. The phase conversion component 230c may be a mechanism, disposed within the tank for extracting the liquid phase of the propellant.

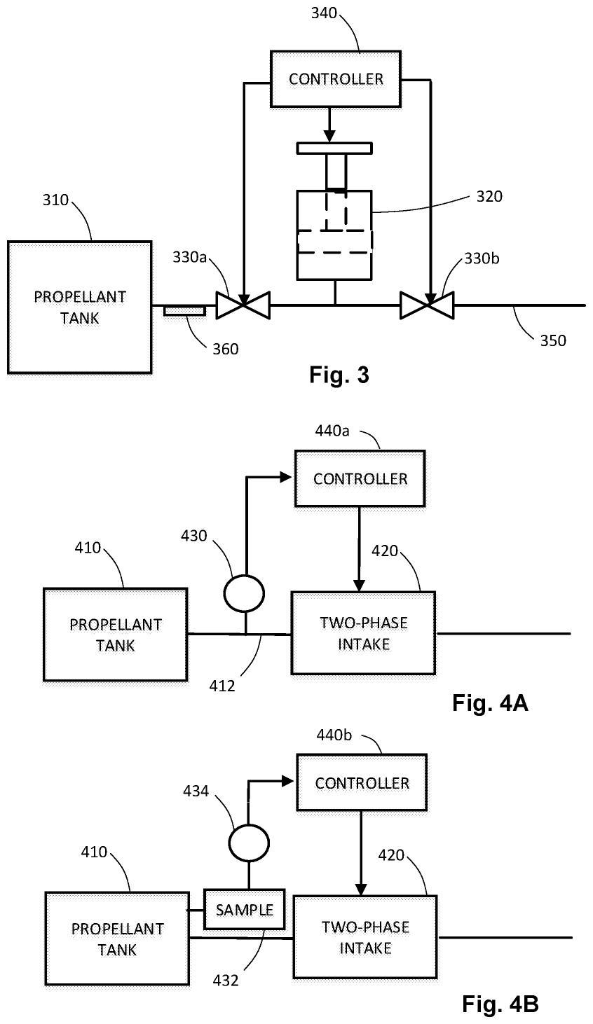

FIG. 3 illustrates an of a propellant management system (e.g., the propellant management system 200a) for converting a two-phase mixture of propellant from a tank 310 into a single phase using a piston pump 320. A tank 310 may be the tank 210a, fluidicly coupled to an outlet line 350. Valves 330a and 330b are disposed in the outlet line 350 upstream and downstream, respectively, of the piston pump 320. A controller 340 controls each of the valves 330a and 330b as well as the piston pump 320. In particular, the controller 340, first causes the valve 330a to open to thereby cause the mixture of the liquid to reach the piston pump 320. Subsequently, the controller 340 causes the valve 330a to close, while the valve 330b remains closed. The controller 340 further causes the piston pump 320 to compress the mixture of phases of the propellant, thereby causing the gaseous propellant to condense. The controller 340 then opens the valve 330b directing the liquid propellant to the outlet line 350.

In some implementations, a cooler (e.g., a thermoelectric cooler) may cool the propellant in a section of the outlet line 350 between the propellant tank 310 and the valve 330a.

In a sense, the components of FIG. 3 implement the two phase intake component 220a and the phase conversion component 230a.

FIG. 4A illustrates a system for controlling a volume flow rate of a two-phase mixture from a tank 410 based on a sensor 430 for detecting a composition of the two-phase mixture. The tank 410 is fluidicly coupled to a two-phase intake component 420 via a line 412. The two-phase intake component 420 is configured to remove propellant from the propellant tank 410 with a variable volumetric flow rate. The sensor 430 is configured to determine the composition of the flow (e.g., a ratio of liquid volume to gas volume) in the section of the line 412 between the tank 410 and the two-phase intake component 420 and/or generate a signal indicative of an amount of liquid in the mixture. A controller 440a may vary the flow rate of the two-phase intake component 420 based at least in part on the signal generated by the sensor 430. The sensor 430 may be an optical sensor, a capacitive sensor, or any other suitable sensor.

In some implementation, the sensor 430 and/or the two-phase intake component 420 may be disposed within the tank 410. The two-phase intake component 420 may be an impeller.

FIG. 4B illustrates another implementation of the system for controlling a volume flow rate of a two-phase mixture from a tank 410. The system includes a sampling pump 432 fluidicly connected to the propellant tank 410 via a line distinct from the line connecting the tank 410 and the two-phase intake component 420. The sampling pump 432 in configured to collect a volumetric sample of the propellant mixture. The system in FIG. 4B further includes a sensor 434, communicatively connected to the controller 440a, and configured to detect the amount of liquid in the volume of the sample. The sensor 434 may then generate a signal indicative of the amount of liquid and/or the ratio of liquid to gas in the sample and communicate the signal to the controller. The controller 440a may vary the flow rate of the two-phase intake component 420 based at least in part on the signal generated by the sensor 434. The detection process of the amount of liquid in the sample using the sensor 434 may consume the sample.

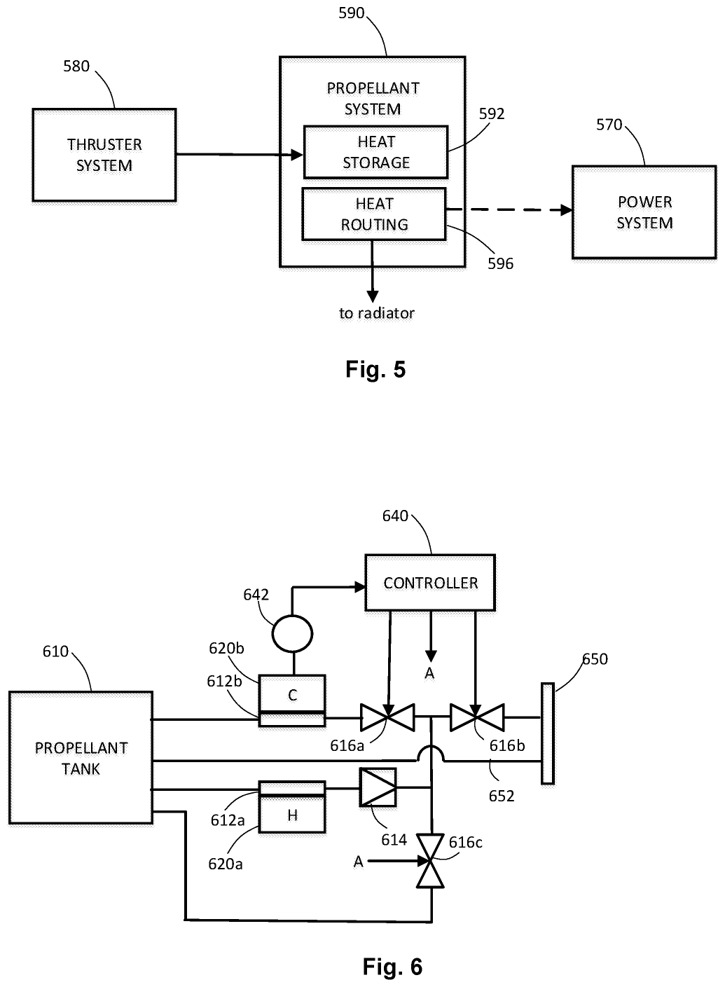

FIG. 5 illustrates a general architecture of using a propellant system for managing heat in a spacecraft. The architecture for managing heat using propellant may thermally and/or fluidicly connect a thruster system 580 (e.g., the thruster system 180), a propellant system 590 (e.g., the propellant system 190) with heat storage components 592 and heat routing components 592, and, in some implementations, a power system 570 (e.g., the power system 170). In some implementations, the thruster system contains a MET thruster configured to consume propellant to generate thrust. The MET thruster includes a microwave source (e.g., including a magnetron) that, in operation, generates excess heat in the thruster system 580. A resonant cavity of the MET thruster may generate additional access heat. The propellant system 590 may use propellant to transfer the access heat away from the thruster system 580 using a heat exchanger and store it in the heat storage elements 592 that may include propellant stored in a tank. In some implementations, the heat storage elements 592 of the propellant system 590 may include a dedicated heat storage tank (e.g., for storing a heated amount of propellant as superheated steam).

The routing elements 596 of the propellant system 590 may direct the excess heat (i.e., the heated propellant) to a subsystem of the spacecraft. In some implementations, the routing elements 596 may direct the heat to a radiator. In other implementations, the subsystem of the spacecraft receiving the excess heat is the power system 570. The power system may include thermal generators, turbines, or other suitable components for converting excess heat to electricity. Additionally or alternatively, the subsystem of the spacecraft receiving the excess heat is the thruster system 580. For example, a portion of the heated propellant steam may be directed to the MET thruster to generate thrust.

FIG. 6 illustrates an example implementation of using a propellant system for managing heat in a spacecraft by pumping propellant through one or more heat exchangers. A propellant tank 610 may be fluidicly coupled to heat exchangers 612a and 612b, that are in thermal connection with respective components 620a and 620b, and, through pump 614, and/or valves 616a,b to the radiator 650. The radiator may include a conduit for the propellant, so as to allow a fluidic connection to the tank 610 downstream of the pump 614 via the radiator return segment 652. A controller 640 may direct the propellant exiting the pump 614 by opening and/or closing the valves 616a, 616b, or 616c. The heat exchanger 612a may be in thermal contact with a component 620a that is at a higher temperature than the propellant in the heat exchanger 612a. Consequently, the propellant passing through the heat exchanger 612a may absorb heat while cooling the component 620a. In some implementations, the component 620a may be a microwave source (e.g., including a magnetron) for a MET thruster. The pump 614 may cooperate with at least one of the valves 616a-c to direct the heated portion of the propellant to a heat sink. For example, the controller 640 may open (i.e., cause to open) the valve 616c to direct the heated propellant to the propellant tank 610. Alternatively, the controller 640 may open the valve 616b to direct the propellant to the radiator 650, thereby directing the excess heat from the component 620a to the radiator 650 that may be thermally connected to a conduit for the propellant. The propellant, having transferred the heat to the radiator 650, may return to the tank 610 via the line segment 652. In some implementations the radiator 650 may be expandable, and may expand in response to the flow of the heated propellant.

Still alternatively, the controller 640 may open the valve 616a, cooperating with the pump 614 to direct the heated propellant to the heat exchanger 612b for transferring the heat the component 620b that may act as a heatsink. In some implementations, the component 620b is a power plant (e.g., including a turbine or a thermoelectric generator) configured to generate electricity. In some other implementations, the component 620b is a spacecraft component that requires a heat input. In some implementations, a sensor 642 may detect the temperature of the component 620b and generate the signal indicative of the temperature for the controller 640. The controller 640 may cause the routing of the heated propellant to the exchanger 612b in response to the signal from the sensor 642. For example, the signal 642 may indicate that the component 620b temperature is below a threshold value and causing the controller 640 to cause the routing of the heated propellant to the exchanger 612b.

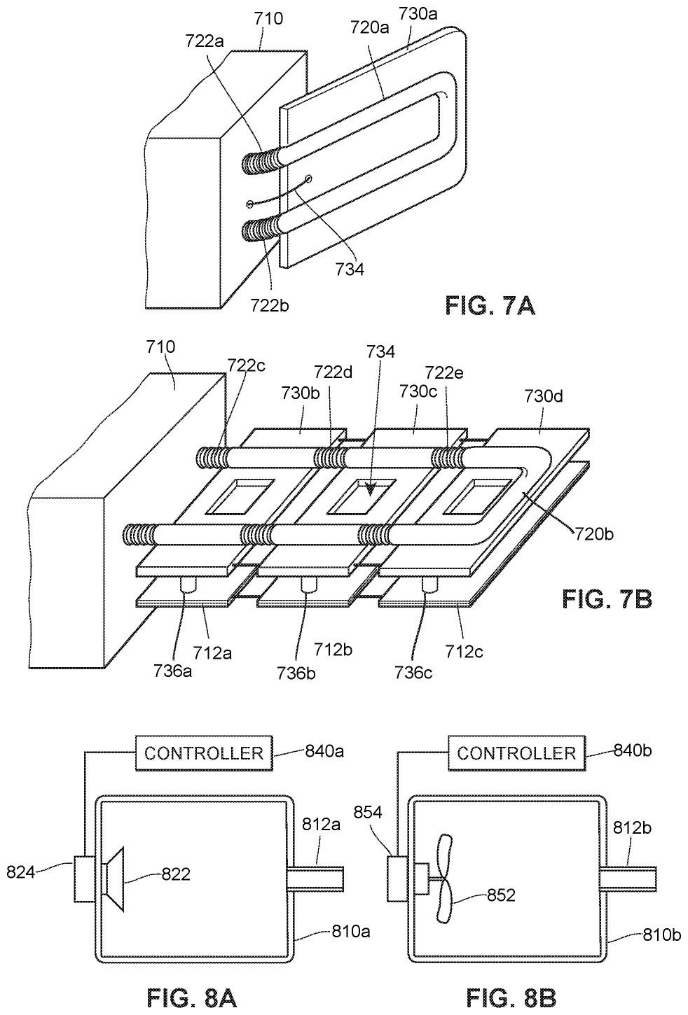

FIG. 7A illustrates a deployable radiator 730a disposed outside of a spacecraft housing 710 and thermally connected to a propellant conduit 720a with two flexible sections 722a,b. the flexible sections 722a,b enable the mechanism 734 to deploy the radiator 730a. In operation, heated propellant, as discussed in the context of FIG. 5 and FIG. 6 may flow through the conduit 720a of the radiator 730a to transfer heat from heated propellant to the radiator 730a.

FIG. 7B illustrates a radiator composed of radiator sections 730b-d disposed outside of the spacecraft housing 710 in an implementation alternative to the one illustrated in FIG. 7A. The radiator sections 730b-d of a radiator are attached, correspondingly, to sections 712a-c that constitute a solar array. The radiator is attached to a back side of the solar array via stand-offs 736a-c and thermally connected to a propellant conduit 720b. The conduit includes flexible sections 722c-e with additional flexible sections not labeled to avoid clutter. As in the context of FIG. 7A, heated propellant may flow through the conduit 720b to transfer heat from heated propellant to the radiator composed of sections 730b-d. The sections 730b-d of the radiator may include openings, such as a window 734 to facilitate radiation by the backside of the solar array.

As discussed in the context of FIG. 6, a pump may direct the heated propellant through the conduit 720a or the conduit 720b.

FIGS. 8A and 8B describe structure and operation of example implementations of the mixers 212a-c in FIGS. 2A-C.

FIGS. 8A and 8B illustrate systems for storing propellant in microgravity comprising corresponding tanks 810a and 810b fluidicly coupled to corresponding outlets 812a and 812b. The tank including an ultrasonic transducer acting as an agitator for increasing circulation of a mixture of liquid and gas in microgravity.

The tank 810a includes an ultrasonic transducer 822 configured as an agitator for increasing circulation of the mixture of liquid and gas propellant stored in the tank 810a in microgravity. The ultrasonic transducer 822 may be driven by an ultrasonic voice coil 824 controlled by a controller 840a. The ultrasonic transducer 822 may be configured to transduce ultrasonic vibrations directly to the mixture of liquid and gas. In other implementations, the ultrasonic transducer 822 may be configured to transduce ultrasonic vibrations to the walls of the tank 810a, shaking the drops agglomerated at the walls. In the latter case, the ultrasonic transducer 822 may be disposed outside of the tank 810.

The tank 810b includes a fan 852 configured as an agitator for increasing circulation of the mixture of liquid and gas propellant stored in the tank 810b in microgravity. The fan 852 may be driven by a motor 853 controlled by a controller 840a.

The controllers 840a,b may activate the corresponding ultrasonic transducer 822 and the fan 852 in response to composition of the mixtures inside the tanks 810a and 810b. For example, the controllers 840a,b may turn on or increase the drive when the volume fraction of liquid propellant to gaseous propellant decreases in the tanks 810a,b.

The following list of aspects reflects a variety of the embodiments explicitly contemplated by the present disclosure.

Aspect 1. A method for managing propellant in a spacecraft, the method comprising: storing propellant in a tank as a mixture of liquid and gas; transferring the propellant out of the tank; converting the mixture of liquid and gas propellant into a single phase, where the single phase is either liquid or gaseous; and supplying the single phase of the propellant to a thruster.

Aspect 2. The method of aspect 1, wherein converting the propellant into a single phase includes converting the mixture of liquid and gas propellant directly into liquid.

Aspect 3. The method of aspect 2, wherein converting the mixture of liquid and gas propellant directly into liquid includes compressing the propellant using a piston.

Aspect 4. The method of aspect 1, wherein converting the mixture of liquid and gas propellant into the single phase includes converting the propellant directly into gas.

Aspect 5. The method of aspect 1, wherein converting the mixture of liquid and gas propellant into a single phase includes: first converting the mixture of liquid and gas propellant into gas, then converting the gas into liquid.

Aspect 6. A system for managing propellant in a spacecraft, the system comprising: a tank for storing propellant as a mixture of liquid and gas; a two-phase intake device configured to operate at a variable volume flow rate; a sensor configured to generate a signal indicative of an amount of liquid in the mixture of liquid and gas; and a controller configured to vary the variable flow rate of the two-phase intake device based at least in part on the signal generated by the sensor.

Aspect 7. The system of aspect 6, wherein the sensor is disposed at an outlet line of the tank.

Aspect 8. The system of aspect 6, wherein the sensor is disposed within the tank.

Aspect 9. The system of aspect 6, wherein the two-phase intake device is a pump.

Aspect 10. The system of aspect 6, wherein the two-phase intake device is an impeller.

Aspect 11. The system of aspect 6, further comprising: a sampling pump configured to remove a sample of the mixture of the propellant stored in the tank, wherein the signal indicative of the amount of liquid in the mixture of liquid and gas is based at least in part on an amount of liquid in the sample.

Aspect 12. A method for transferring propellant out of a tank that stores the propellant in microgravity as a mixture of gas and liquid, the method comprising: pumping with a two-phase pump a certain volume of propellant via an outlet line; determining, using a sensor, a ratio of liquid and gas in the certain volume; and setting a speed of pumping with the two-phase pump based at least in part on the determined ratio.

Aspect 13. A system for managing heat in a spacecraft, the system comprising: a tank configured to store a propellant; a microwave electro-thermal (MET) thruster configured to consume the propellant to generate thrust, the thruster including a microwave source that, in operation, generates excess heat; and a heat exchanger configured to transfer the excess heat to the propellant stored in tank.

Aspect 14. The system of aspect 13, wherein the microwave source includes a magnetron.

Aspect 15. A method for managing heat in a spacecraft, the method comprising operating a microwave electro-thermal (MET) thruster including a microwave source, wherein operating the MET thruster includes: consuming propellant, and generating excess heat; heating an amount of the propellant using the excess heat; storing the excess heat by storing the heated amount of the propellant in a tank; and directing the excess heat to a subsystem of the spacecraft.

Aspect 16. The method of aspect 15, wherein directing the excess heat to the subsystem of the spacecraft includes: directing the excess heat to a radiator.

Aspect 17. The method of aspect 15, wherein directing the excess heat to the subsystem of the spacecraft includes: directing the excess heat to a power system for converting to electricity.

Aspect 18. The method of aspect 15, wherein directing the excess heat to the subsystem of the spacecraft includes directing the heated amount of the propellant to a thruster.

Aspect 19. A system for managing heat in a spacecraft, the system comprising a tank configured to store a propellant; a microwave electro-thermal (MET) thruster configured to consume the propellant to generate thrust, the thruster including a microwave source that, in operation, generates excess heat; a heat exchanger configured to transfer the excess heat to a portion of the propellant in a conduit, thereby heating the portion of the propellant; and a pump configured to direct the heated portion of the propellant to a heat sink.

Aspect 20. The system of aspect 19, wherein the heatsink is a radiator.

Aspect 21. The system of aspect 20, wherein the radiator is expandable.

Aspect 22. The system of aspect 19, wherein the heatsink is a power plant, configured to generate electricity.

Aspect 23. The system of aspect 22, wherein the power plant includes a thermal generator.

Aspect 24. The system of aspect 19, wherein the heatsink is a spacecraft component that requires a heat input

Aspect 25. The system of aspect 24, further comprising: a sensor, configured to detect a temperature of the spacecraft component; and a controller, configured to direct the heated portion of the propellant toward the spacecraft component based at least in part on the detected temperature.

Aspect 26. A system for managing heat in a spacecraft, the system comprising: a deployable radiator; a conduit having a flexible section and configured for carrying a propellant, the conduit in a thermally conductive connection with the deployable radiator.

Aspect 27. A system for managing heat in a spacecraft, the system comprising: a radiator, disposed at a back side of a solar panel; a conduit having a flexible section and configured for carrying a propellant, the conduit in a thermally conductive connection with the radiator; and a pump configured to pump propellant through the conduit.

Aspect 28. The system of aspect 27, wherein the radiator is attached to the backside of the solar panel with stand-offs, so as to substantially reduce conduction of heat from the solar panel to the radiator.

Aspect 29. A system for storing propellant in microgravity comprising: a tank for storing propellant as a mixture of liquid and gas; and an agitator, configured to increase circulation of the mixture of liquid and gas in microgravity; and a controller configured to activate the agitator.

Aspect 30. The system of aspect 29, wherein the agitator is an ultrasonic transducer.

Aspect 31. The system of aspect 29 disposed within the tank and configured to transduce ultrasonic vibrations directly to the mixture of liquid and gas.

Aspect 32. The system of aspect 29, wherein the agitator is a fan disposed within the tank.

1. A method for managing propellant in a spacecraft, the method comprising:
storing propellant in a tank as a mixture of liquid and gas;
transferring the propellant out of the tank;
converting the mixture of liquid and gas propellant into a single phase, where the single phase is either liquid or gaseous; and
supplying the single phase of the propellant to a thruster.

2. The method of claim 1, wherein
converting the propellant into a single phase includes converting the mixture of liquid and gas propellant directly into liquid.

3. The method of claim 2, wherein
converting the mixture of liquid and gas propellant directly into liquid includes compressing the propellant using a piston.

4. The method of claim 1, wherein
converting the mixture of liquid and gas propellant into the single phase includes converting the propellant directly into gas.

5. The method of claim 1, wherein
converting the mixture of liquid and gas propellant into a single phase includes:
first converting the mixture of liquid and gas propellant into gas, then converting the gas into liquid.

6. The method of claim 1, wherein converting the mixture of liquid and gas propellant into the single phase includes drawing the liquid through a wicking material into a liquid-phase pump.

7. The method of claim 6, further comprising:
causing a low-density vapor-phase of the propellant to condense onto a cooled complex surface at a temperature below a dew point of the propellant but above the freezing point of the propellant.

8. The method of claim 6, wherein the complex surface is composed of loosely packed hydrophilic fibers.

9. The method of claim 6, further comprising:
progressively compressing, using a peristaltic-type pump, the wicking material along a wave which forces liquid out of the wicking material and toward an output port.

10. The method of claim 1, wherein converting the mixture of liquid and gas propellant into the single phase includes:
evaporating the mixture to a complete vapor phase; and
condensing the complete vapor phase to a complete liquid phase.

11. The method of claim 10, wherein the evaporating includes:
directing a stream of the mixture through a restrictive orifice to generate an abrupt pressure drop to flash-evaporate the mixture.

12. The method of claim 11, wherein the condensing includes:
adding heat to the mixture using a warmed evaporator to generate a low-pressure vapor;
compressing a stream of the low-pressure vapor to generate a pressurized vapor with a higher pressure using a vapor pump; and
condensing the pressurized vapor to the complete liquid phase using a cooled condenser.

13. The method of claim 12, further comprising:
transferring heat from the cooled condenser to the warmed evaporator.

14. The method of claim 10, wherein evaporating the mixture to the complete vapor phase includes passing the mixture in pulses through a fast-acting valve into a low-pressure chamber.

15. A spacecraft comprising:
a tank storing propellant in a tank as a mixture of liquid and gas;
a thruster configured to consume the propellant to generate thrust;
a two-phase intake component configured to configured to receive the mixture of liquid and gas from the tank; and
a phase conversion component configured to (i) receive the mixture of liquid and gas from the two-phase intake component, (ii) convert the mixture of liquid and gas into a single phase of the propellant, and (iii) supply the single phase of the propellant to the thruster.

16. The spacecraft of claim 15, wherein:
the two-phase intake component includes porous wicking material to absorb the mixture; and
the phase conversion component includes a mechanism configured to compress the porous wicking material to thereby extract a liquid phase of the propellant.

17. The method of claim 16, wherein:
the phase conversion component further includes a cooled complex surface, and
the phase conversion component causes a low-density vapor-phase of the propellant to condense onto the cooled complex surface at a temperature below a dew point of the propellant but above the freezing point of the propellant.

18. The spacecraft of claim 17, wherein the complex surface is composed of loosely packed hydrophilic fibers.

19. The spacecraft of claim 15, wherein:
the phase conversion component includes a piston configured to convert the mixture of liquid and gas propellant directly into liquid.

20. The spacecraft of claim 15, wherein the phase conversion component is configured to:
evaporate the mixture to a complete vapor phase; and
condense the complete vapor phase to a complete liquid phase.
